(19) United States
(12) Patent Application Publication
(10) Pub. No.: US 2005/0257706 A1
(43) Pub. Date: Nov. 24, 2005

(54) Printing machines

(75) Inventors: Pierre Simon, ORLEANS (FR); Bernard Six, Olivet (FR)

Correspondence Address: YOUNG & THOMPSON, 745 SOUTH 23RD STREET, 2ND FLOOR, ARLINGTON, VA, 22202, US

(73) Assignee: KOMORI-CHAMBON SA, ORLEANS (FR)

(21) Appl. No.: 10/523,026

(22) PCT Filed: Jul. 31, 2003
(86) PCT No.: PCT/FR03/02427

§ 371 Date: Feb. 2, 2005

(30) Foreign Application Priority Data
Aug. 2, 2002 (FR) 02.09879

(51) Int. Cl. B41F 13/10

(52) U.S. Cl. 101/376

(57) ABSTRACT

A device for fixing a printing sleeve (3), in particular a printing form or a blanket drum, to a drive cylindrical shaft (1) on which a deformable cover (2) is arranged between the printing sleeve (3) and the shaft (1). The surface of the shaft (1) is grooved by a series of cavities (7) separated by bearing surfaces (12) which the cover (2) is rested on. The device also comprises an element for providing with the radial deformation of the deformable areas of the cover (2) by overpressure produced on the external face thereof or under-pressure on the internal face thereof. The device is characterized in that the shaft (1) and the printing sleeve (3) are provided with angular indexing elements (25).

The present invention relates to a printing machine and more particularly to a device intended to ensure fixation and positioning of a removable printing sleeve on a support shaft of such a machine.

It is known that, in particular, the plate cylinders of the printing machines are usually constituted by a cylindrical or conical shaft, on which is fixed a sleeve bearing, on its outer peripheral part, the engraving intended to make the print. It is also known that it is important, on such machines, that the user be in a position to replace one sleeve by another, rapidly and easily.

It has therefore been proposed to ensure fixation of a printing sleeve on the cylindrical shaft by means of a hooping. To that end, there is exerted on the internal face of the sleeve a stress adapted to provoke an expansion of the latter which then allows it to be fitted on the shaft. Once the fit is effected, it suffices to eliminate the stress which ensures the expansion of the sleeve for the latter then to be pressed strongly on the shaft.

Deformation of the sleeve is usually obtained by blowing pressurized air between the internal surface of the latter and the external surface of the shaft, through holes of small diameter provided in the latter.

Such deformation, of the order of some tenths of millimetre for metal sleeves, and of some millimetres for sleeves of composite materials, is obtained without difficulty when the sleeves present a small thickness.

It has also been proposed to ensure fixation of a sleeve on its shaft by provoking a swelling of the latter after its positioning, under the effect of a high hydraulic pressure (of the order of about 2.10⁷ Pa), and maintaining this pressure in the course of functioning. Such a mode of fixation makes it possible to obtain a perfect tightening of the sleeve on the shaft, as well as a very good concentricity of the sleeve with respect thereto in the course of use. However, the swelling of the shaft has for effect to provoke a deformation of the sleeve which, even when it is slight, is detrimental to the good precision of the printing device. Moreover, in such a device, the necessity of maintaining, the hydraulic control pressure in the course of functioning, involves from the practical standpoint of implementation, employing particularly complex and therefore expensive devices.

Finally, it has been proposed in Patent EP-A-0855268, to ensure the hold of a sleeve of anilox on a cylindrical drive shaft by disposing between the sleeve and the shaft a deformable cover and by hollowing out on the external surface of this shaft a series of cavities separated by holding surfaces on which the cover is in abutment, and rendering this cover adapted to be deformed so that it may present two positions, namely a position of assembly in which each part of its surface, called deformable area, located opposite a cavity, is deformed in the latter under the action of a stress, and a position of rest in which the deformable area has resumed, at least in part, its initial shape, so as to be applied against the internal surface of the sleeve, this device comprising means adapted to ensure radial deformation of the deformable areas of the cover.

The present invention has for its object to propose means for angularly positioning in precise manner the printing forms of a printing machine or a blanket cylinder when the latter is not continuous and comprises an interruption.

The present invention thus has for its object a device for fixing a printing sleeve, particularly a printing form or a blanket cylinder on a cylindrical drive shaft in which a deformable cover is disposed between the sleeve and the shaft, the surface of the shaft having a series of cavities hollowed out therein, separated by bearing surfaces on which the cover is in abutment, the device comprising means adapted to ensure radial deformation of the deformable areas of the cover under the effect of an over-pressure on the external face of the latter or an under-pressure on its internal face, characterized in that the shaft and the sleeve are provided with angular indexing means.

These angular indexing means may be constituted by a finger disposed on one of the two pieces to be indexed and which is adapted to be positioned in a cavity, of complementary shape, of the other piece. This finger may be mounted to move in a housing and positioned in said cavity under the action of elastic means, such as for example a compression spring.

The sleeve will preferably be covered by a removable thin tube indexed with respect thereto and the separation surface between the internal surface of the tube and the external surface of the sleeve will be in communication with means for controlled supply of pressurized air. This separation surface may be connected by at least one conduit with the controlled supply of pressurized air of the separating surface existing between the sleeve and the cover.

In one embodiment of the invention, the downstream end of each conduit for controlled supply of pressurized air of the separating surface existing between the sleeve and the cover, will be provided with a control valve making it possible to send the flow of pressurized air either towards this latter separation surface, when it is desired to remove the sleeve, or towards the separation surface of the sleeve and the tube when it is desired to remove the latter.

The control valve will preferably be of the rotating type and the angular indexing means will be constituted by a finger fast with this valve so that this finger is in mesh with the sleeve when the valve is positioned to send the flow of pressurized air in the direction of the tube.

Furthermore, the valve may comprise a finger adapted, in a given position, to block the axial displacement of the sleeve.

Various forms of embodiment of the present invention will be described hereinafter by way of non-limiting example, with reference to the accompanying drawings, in which:

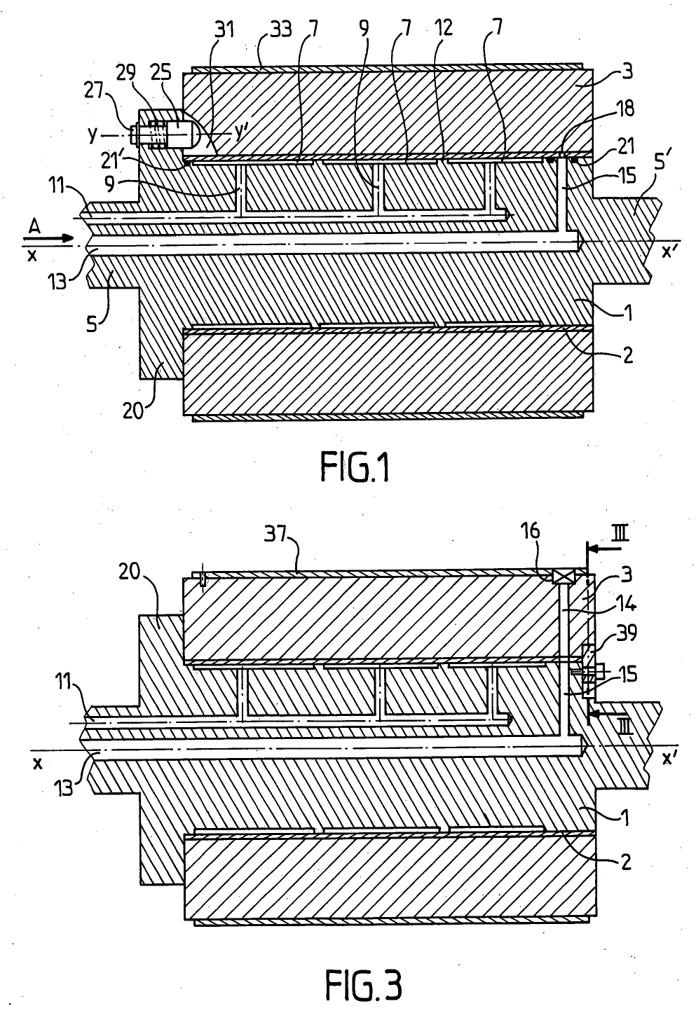

FIG. 1 is a partial view in longitudinal cross section of a device according to the invention.

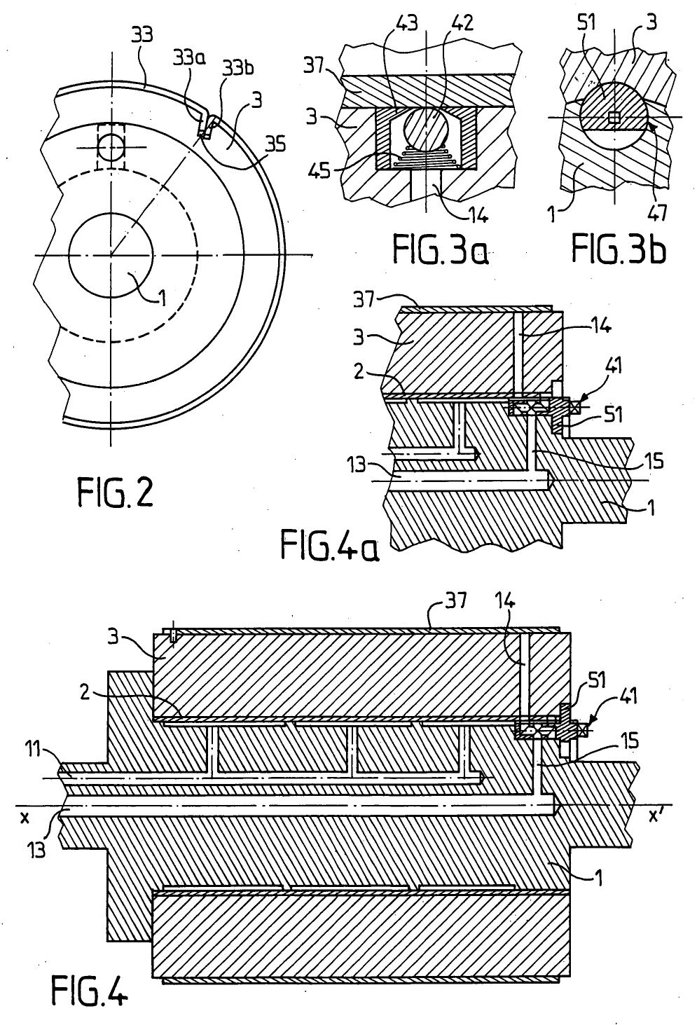

FIG. 2 is a partial side view of the device shown in FIG. 1.

FIG. 3 is a partial view in longitudinal cross section of a variant embodiment of the device according to the invention.

FIG. 3a is an enlarged partial view of a closure valve that may be used in the embodiment of the present invention shown in FIG. 3.

FIG. 3b is a view in detail of a control member of a valve used in the embodiment of FIGS. 4 and 4a.

FIG. 4 is a partial view in longitudinal cross section of another variant embodiment of the device according to the invention, the closure valve being tipped in a first position.

FIG. 4a is a partial view of the form of embodiment of the invention shown in FIG. 4, the closure valve being tipped in a second position.

FIG. 1 shows an interchangeable printing cylinder according to the invention which may equally well be, in the case of offset printing, a plate or blanket cylinder; in the case of a flexography printing, a plate cylinder; or in the case of photogravure, an engraved cylinder and paper cylinder.

In FIG. 1, the device according to the invention is constituted by a cylindrical shaft 1 of longitudinal axis xx′, which is intended to support and to drive a sleeve 3. The shaft 1 comprises, at each of its ends, headstocks 5, 5′ intended to ensure its hold and drive in rotation. The shaft 1 is hollowed out, on its periphery, with three annular cavities 7 which are each in communication, by a radial conduit 9, with a longitudinal channel 11 which opens out at one end of the shaft 1, the cavities 7 being separated by cylindrical, non-hollowed bearing surfaces 12. A cover 2 of small thickness is fitted on the bearing surfaces 12 of the shaft 1. This cover is made of glass-fibre reinforced epoxy resin.

The shaft 1 is hollowed out with a second axial, longitudinal channel 13 which also opens out at one end of the shaft 1 and which is in communication with five radial conduits 15 (of which only one has been shown in the drawings).

In known manner, the cover 2 is pierced, opposite each conduit 15, with an orifice 18. On each side of this orifice, the shaft 1 is hollowed out with two circular grooves in which O-rings 21 are disposed. Another O-ring 21′ is disposed in a circular groove at the other end of the shaft 1.

The sleeve 3 is constituted in particular by a metal, for example of aluminium. It may equally well be constituted by synthetic materials employing a structure, particularly in honeycomb form, so as to present considerable rigidity.

By injecting a flow of pressurized air A via the axial channel 13, so that the flow traverses the cover 2 via the orifices 18, and creates, between the surface of the internal wall of the sleeve 3 and the surface of the external wall of the cover 2, a film of air under pressure, those parts of the cover 2 which are located opposite the cavities 7, are pushed inside the latter, which makes it possible easily to introduce said sub-assembly inside the sleeve 3.

The shaft 1 is provided with a shoulder 20 against which the sleeve 3 is applied. This shoulder is pierced with a cylindrical cavity of axis yy′ parallel to axis xx′ of the shaft 1 and which opens to the outside via a hole of smaller diameter. The cavity receives a cylindrical finger 25 and the hole receives the guiding shank 27 thereof. A compression spring 29 urges the finger 25 towards the outside and the latter is retained in its cavity by holding means (of circlips type) provided on the guiding shank 27. Furthermore, the sleeve 3 is provided with a radial slot 31 (possibly made by a milling cutter), whose width corresponds to the diameter of the finger 25, so that, in position of functioning, the latter penetrates in said slot and thus ensures an angular indexation of the sleeve 3 with respect to the shaft 1.

The fact that the finger 25 is retractable inside the shoulder 20 makes it possible to avoid the deterioration of the sleeve 3 which might occur, at the end of stroke, in the event of the slot 31 not being located opposite the finger 25, and this by reason of the mode of displacement with very low friction (displacement on air cushion) of the sleeve 3.

The indexing finger 25 also presents another advantage. In effect, when one changes format and passes to a sleeve of large diameter, it is possible that the existing friction between the shaft 1 and the sleeve 3 is not sufficient to transmit the torque necessary for deriving the sleeve in rotation, particularly in offset for the plate and blanket cylinders. In such a situation, the finger 25 then participates in the transmission of a part of the torque, and it may be employed even when no function of indexation proves necessary, as is the case when a continuous blanket is employed.

In the present form of embodiment of the invention, the sleeve 3 receives a plate 33 whose external face constitutes the active surface of the cylinder and which is fixed on the latter by embedding its two ends 33a and 33b in a longitudinal slot 35 hollowed out in the sleeve 3, as shown in FIG. 2.

The external plate may, of course, be constituted differently and be formed for example of a fine tube 37 whose external surface constitutes the active part. Assembling and dismantling of this tube 37 will be effected by creating an overpressure of air between its internal surface and the external surface of the sleeve 3.

To that end, as shown in FIG. 3, use may be made of the same air supply conduits and orifices 13 as those used for the dismantling/re-assembly of the sleeve 3, and radial conduits 14 (of which only one is shown in the drawings) conduct the pressurized air between the internal surface of the tube 37 and the external surface of the sleeve 3. In order to avoid the emergence of the sleeve 3 when it is desired to extract the tube 37, a removable retaining stop 39 has been provided, which prevents any slide of the sleeve on the shaft 1 during this operation.

This function of hold may also be performed by the indexing finger which in that case will be disposed on the side opposite the shoulder 20 on the side from which the sleeve 3 is extracted.

In such a form of embodiment of the invention, there will be provided, at the exit of each conduit 14 traversing the sleeve 3, a valve 16 ensuring obturation of the latter when the tube 37 is not in place on the sleeve 3.

As shown in FIG. 3a, this valve may be constituted by a ball 42 which is applied against a valve seat 43 by a compression spring 45. The valve seat 43 is such that, when the tube 37 is in place on the sleeve 3, the ball 42 is pushed slightly by the latter so that a space is formed between the ball and the valve seat 43, thus leaving passage for the pressurized air, while, when the tube 37 is not in position on the sleeve 3, the spring 45 and the pressurized air push the ball 42 against the valve seat 43 and then obturates the latter.

As shown in FIGS. 3b, 4, 4a, in place of such a valve 16, it is also 20 possible to use a valve 41 making it possible to direct the flow of pressurized air coming from conduits 15 either between the sleeve 3 and the cover 2 (dismantling/re-assembly of the sleeve 3), or between the tube 37 and the sleeve 3 (dismantling/re-assembly of the tube 37).

As shown in FIG. 3b, the control member of this valve 41 may be constituted by an element 47 in the form of a half-moon of which the position of the rounded part 51 determines the immobilization or the axial release of the sleeve 3. In this way, when, as shown in FIGS. 3b and 4, the rounded part 51 is in high position, it blocks the sleeve 3 axially (this corresponding to a position of the valve 41 allowing the flow of pressurized air to be conducted between the tube 37 and the sleeve 3 so as to allow the withdrawal of the tube 37). On the contrary, as shown in FIG. 4a, when the control of the valve 41 is in a position such that its rounded part 51 is in low position, the latter no longer blocks the sleeve 3 (this corresponding to a position of the valve 41 allowing the flow of pressurized air to be conducted between the cover 2 and the sleeve 3), so as to allow the withdrawal of the latter.

1. Device for fixing a printing sleeve (3), particularly a printing form or a blanket cylinder on a cylindrical drive shaft (1) in which a deformable cover (2) is disposed between the sleeve (3) and the shaft (1), the surface of the shaft (1) having a series of cavities (7) hollowed out therein, separated by bearing surfaces (12) on which the cover (2) is in abutment, the device comprising means adapted to ensure radial deformation of the deformable areas of the cover (2) under the effect of an over-pressure on the external face of the latter or an under-pressure on its internal face, characterized in that the shaft (1) and the sleeve (3) are provided with angular indexing means (25).

2. Device according to claim 1, characterized in that the means adapted to ensure radial deformation of the deformable areas of the cover (2) are constituted by a controlled supply (13) of pressurized air of the separating surface existing between the sleeve (3) and the cover (2).

3. Device according to claim 1, characterized in that the angular indexing means are constituted by a finger (25) disposed on one of the two pieces (1, 3) to be indexed, namely the shaft (1) or the sleeve (3), and adapted to be positioned in a housing (31), of complementary shape, provided in the other piece (3, 1).

4. Device according to claim 3, characterized in that the finger (25) is mounted to move elastically in a cavity under the action of a spring (29).

5. Device according to claim 1, characterized in that the sleeve (3) is covered by a removable thin tube (37) indexed with respect thereto.

6. Device according to claim 5, characterized in that the separation surface between the internal surface of the tube (37) and the external surface of the sleeve (3) is in communication with means for controlled supply of pressurized air.

7. Device according to claim 6, characterized in that said separation surface is connected by at least one conduit (14, 15) with the controlled supply (13) of pressurized air of the separating surface existing between the sleeve (3) and the cover (2).

8. Device according to claim 7, characterized in that the conduit (14), connecting the controlled supply (13) of pressurized air of the separation surface existing between the sleeve (3) and the shaft (1), comprises at its downstream end a closure valve (16) preventing the emergence of air when the sleeve (3) is not coated with a tube (37).

9. Device according to claim 7, characterized in that the downstream end of each conduit (15) for controlled supply of pressurized air of the separating surface existing between the sleeve (3) and the cover (2), is provided with a control valve (41) making it possible to send the flow of pressurized air either towards this latter separation surface, when it is desired to remove the sleeve (3), or towards the separation surface of the sleeve (3) and the tube (37) when it is desired to remove the latter.

10. Device according to claim 9, characterized in that the control valve (41) is of the rotating type and the angular indexing means are constituted by a finger fast with this valve (41) so that this finger is in mesh with the sleeve (3) when the valve (41) is positioned to send the flow of pressurized air in the direction of the tube (37).

11. Device according to claim 9, characterized in that the valve (41) comprises a finger adapted, in a given position, to block the axial displacement of the sleeve (3).

12. Device according to claim 2, characterized in that the angular indexing means are constituted by a finger (25) disposed on one of the two pieces (1, 3) to be indexed, namely the shaft (1) or the sleeve (3), and adapted to be positioned in a housing (31), of complementary shape, provided in the other piece (3, 1).

13. Device according to claim 12, characterized in that the finger (25) is mounted to move elastically in a cavity under the action of a spring (29).

14. Device according to claim 10, characterized in that the valve (41) comprises a finger adapted, in a given position, to block the axial displacement of the sleeve (3).
